(19) United States
(12) Patent Application Publication
(10) Pub. No.: US 2026/0228436 A1
(43) Pub. Date: Aug. 6, 2026

(54) COMPUTING SYSTEMS AND METHODS FOR MACHINE LEARNING TO AUTOMATICALLY GENERATE TOPICS LINKED TO DIGITAL TEXT

(71) Applicant: The Toronto-Dominion Bank, Toronto (CA)

(72) Inventors: Chon-Kit PUN, Toronto (CA); Wenjia ZHU, Vancouver (CA); Sagar Neel PURKAYASTHA, Calgary (CA); Tom CHICK, Toronto (CA); Robin Jiangning LUO, Toronto (CA)

(21) Appl. No.: 19/044,063

(22) Filed: Feb. 3, 2025

(51) Int. Cl. G06F 40/30; G06F 16/35; G06F 40/216

(52) U.S. Cl. CPC G06F 40/30; G06F 16/35; G06F 40/216

(57) ABSTRACT

Computing systems and methods for discovering new topics from digital documents are provided, including using a natural language neural network. Digital documents are processed using an encoder to obtain vectors, and the vectors are processed to form clusters. Topics are identified in association with each of the clusters. Based on the clusters, a word-topic matrix of probabilities of words detected in each topic is computed. A word-document matrix of probabilities of words detected in each one of the digital documents is also computed. A topic-document matrix of probabilities of each one of the plurality of topics in each one of the digital documents is then computed by factorizing the previous two matrices. This third matrix is then used to compute and output a topic distribution for each of the digital documents, which shows the topics generated by the computing system.

### TECHNICAL FIELD

The disclosed exemplary embodiments relate to computer-implemented systems and methods for machine learning to automatically generate topics linked to digital text. In particular, the machine learning computations including processing unstructured natural language data.

### BACKGROUND

Computing systems ingest digital text from various sources. In some cases, the text includes natural language and, therefore, it can be challenging for computing systems to categorize the digital text based on unknown or undefined topics. In some cases, computing systems include a list of pre-defined topics, and a person attempts to manually associate (via a user interface) digital text with one of the pre-defined topics. However, approaches that include manual inputs in some cases lead to inconsistent topic assignment and are constrained by the pre-defined topics. In some other cases, machine learning computing systems are used to extract themes.

### SUMMARY

The following summary is intended to introduce the reader to various aspects of the detailed description, but not to define or delimit any invention.

In at least one broad aspect, there is provided a server system for automatically generating a plurality of topics from a plurality of digital documents, the server system comprising: a memory, a network interface, and a processor, the processor operably coupled to the memory and the network interface. The processor is configured to: ingest the plurality of digital documents; process the plurality of digital documents using an encoder to respectively obtain a plurality of vectors; cluster the plurality of vectors to identify a plurality of clusters from amongst the plurality of vectors; identify the plurality of topics that are respectively associated with the plurality of clusters; compute a word-document matrix of probabilities of words detected in each one of the plurality of digital documents; compute a word-topic matrix of probabilities of words detected in each topic; compute a topic-document matrix of probabilities of each one of the plurality of topics in each one of the plurality of documents based on the word-document matrix of probabilities and the word-topic matrix of probabilities; and compute and output a topic distribution for each of the plurality of digital documents, wherein a given topic distribution comprises one or more probabilities of one or more topics, from amongst the plurality of topics, that are associated with a given digital document.

In some cases, the processor is configured to compute the topic-document matrix of probabilities of each one of the plurality of topics in each one of the plurality of the digital documents by at least factorizing the word-document matrix of probabilities by the word-topic matrix of probabilities.

In some cases, a given topic, from amongst the plurality of topics, comprise one or more statistically significant words found in a given cluster of documents from amongst the plurality of clusters.

In some cases, each of the plurality of documents comprises natural language, and the plurality of digital documents are transformed into the plurality of vectors using a natural language neural network model.

In some cases, the processor is configured to transform the plurality of documents into the plurality of vectors by at least: transforming the plurality of documents into a plurality of high dimensional vectors with a first number of dimensions, using a bidirectional encoder representations from transformers (BERT) model in the encoder; and transform the plurality of high dimensional vectors to the plurality of vectors, wherein the plurality of vectors has a second number of dimensions less than the first number of dimensions.

In some cases, the processor is configured to compute the topic distribution for each one of the plurality of digital documents as a Dirichlet distribution.

In some cases, the processor is further configured to compute a graph of the plurality of vectors, each one of the plurality of vectors associated with a set of statistically significant words observed respectively in each one of the plurality of documents, wherein the each one of the plurality of vectors respectively corresponds to the each one of the plurality of digital documents.

In some cases, the processor is further configured to render a graphical user interface that displays at least a subset of the topic distributions for a respective subset of the plurality of digital documents. In some cases, the processor renders a graphical user interface (GUI) that displays at least the given topic in association with the given digital document, or an identifier of the given digital document.

In some cases, the processor is further configured to ingest an additional plurality of digital documents; process the additional plurality of digital documents along with the plurality of digital documents to determine if there are one or more new topics; and, when there are one or more new topics, generate a new output comprising the one or more new topics.

In some cases, the processor is further configured to render a graphical user interface that displays an indicator identifying the one or more new topics from amongst the plurality of topics.

In at least another broad aspect, a method is provided for automatically generating a plurality of topics from a plurality of digital documents, and the method is executed in a computing environment comprising one or more processors and memory. The method comprises: ingesting the plurality of digital documents; processing the plurality of digital documents using an encoder to respectively obtain a plurality of vectors; clustering the plurality of vectors to identify a plurality of clusters from amongst the plurality of vectors; identifying the plurality of topics that are respectively associated with the plurality of clusters; computing a word-document matrix of probabilities of words detected in each one of the plurality of digital documents; computing a word-topic matrix of probabilities of words detected in each topic; computing a topic-document matrix of probabilities of each one of the plurality of topics in each one of the plurality of documents based on the word-document matrix of probabilities and the word-topic matrix of probabilities; and computing and outputting a topic distribution for each of the plurality of digital documents, wherein a given topic distribution comprises one or more probabilities of one or more topics, from amongst the plurality of topics, that are associated with a given digital document.

In some cases, the method further comprises computing the topic-document matrix of probabilities of each one of the plurality of topics in each one of the plurality of the digital documents by at least factorizing the word-document matrix of probabilities by the word-topic matrix of probabilities.

In some cases, a given topic, from amongst the plurality of topics, comprises one or more statistically significant words found in a given cluster of documents from amongst the plurality of clusters.

In some cases, each of the plurality of documents comprises natural language, and the plurality of digital documents are transformed into the plurality of vectors using a natural language neural network model.

In some cases, the method further comprises processing the plurality of documents to generate the plurality of vectors by at least: transforming the plurality of documents into a plurality of high dimensional vectors with a first number of dimensions, using a bidirectional encoder representations from transformers (BERT) model in the encoder; transforming the plurality of high dimensional vectors to the plurality of vectors, wherein the plurality of vectors has a second number of dimensions less than the first number of dimensions.

In some cases, the method further comprises computing the topic distribution for each one of the plurality of digital documents as a Dirichlet distribution.

In some cases, the method further comprises computing a graph of the plurality of vectors, each one of the plurality of vectors associated with a set of statistically significant words observed respectively in each one of the plurality of documents, wherein the each one of the plurality of vectors respectively corresponds to the each one of the plurality of digital documents.

In some cases, the method further comprises rendering a graphical user interface that displays at least a subset of the topic distributions for a respective subset of the plurality of digital documents. In some cases, the method further comprises rendering a GUI that displays at least the given topic in association with the given digital document, or an identifier of the given digital document.

In some cases, the method further comprises ingesting an additional plurality of digital documents; process the additional plurality of digital documents along with the plurality of digital documents to determine if there are one or more new topics; when there are one or more new topics, generating a new output comprising the one or more new topics; and rendering a graphical user interface that displays an indicator identifying the one or more new topics from amongst the plurality of topics.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1A is a schematic block diagram of a system for processing fraudulent data from different data sources in accordance with at least some embodiments;

FIG. 1B is a schematic block diagram of a cloud computing platform of FIG. 1A for computing topics from digital documents in accordance with at least some embodiments;

FIG. 2 is a block diagram of a computer in accordance with at least some embodiments;

FIG. 3 is a flowchart diagram showing the flow of data for discovering topics from digital documents in accordance with at least some embodiments;

FIG. 4 is a flowchart diagram of an example method of computing topics from digital documents in accordance with at least some embodiments;

FIG. 5 is a flowchart diagram of an example method of computing new topics from additional digital documents in accordance with at least some embodiments; and

FIG. 6 is a schematic diagram of an example graphical user interface (GUI) of a topic discovery application in accordance with at least some embodiments.

### DETAILED DESCRIPTION

In some cases, computing systems ingest a large volume of digital text. For example, in computing systems that are used in relation to people (e.g., customer relations, sales, healthcare, human resources, project management, social media, news, academia, etc.), digital text from many different sources (e.g., different data accounts, different devices, etc.) is ingested and stored. In some cases, the digital text includes natural language and it is desirable for computing systems to automatically extract topics from the digital text. In some cases, there are hundreds or thousands of digital documents, each including digital text representative of natural language. In some cases, each digital document is a comment, which may be associated with a digital account or a digital ID.

In some cases, existing machine learning computing systems are used extract themes. In some cases, these existing computing operations are computationally resource intensive. In some cases, these existing computing operations are unable to robustly surface new topics from large volumes of digital documents. In some cases, a larger the amount of digital documents leads to more difficulty, since intermediary data extracted from the digital documents could lead to data redundancy or unintentional data filtering, or both.

In some cases, a cloud-based computing system is provided to discover topics associated with each digital document, and includes the process of: embedding (or transformation); clustering to label each document with a topic; factorizing different sets of probabilities to obtain one or more probabilities of one or more topics associated with each digital document; and computing the topic distribution for each document.

In some cases, a computing system is provided that that automatically discovers topics associated with digital documents. The topics are not pre-defined, but instead are obtained from the digital documents. In some cases, an individual digital document is an individual comment. In some cases, each digital document is a response to a questionnaire, that includes questions such as: (i) what do you feel about the experience?, and (ii) what do you think we can do better?. The responses to the questionnaire are in natural language.

In some cases, the digital documents are ingested using a cloud computing platform. The computing system applies transformer-based embedding to learn the contextual meaning of the verbatim of each document and groups the documents them according to their contextual similarity.

In some cases, a computing process generally includes: (1) embedding (or transformation); (2) clustering to label each digital document with a topic; (3) factorizing different sets of probabilities to obtain one or more probabilities of one or more topics associated with each document; and (4) computing the topic distribution for each digital document.

Embedding (or transformation): The computing system executes embedding by using a Bidirectional Encoder Representations from Transformers (BERT) mode to obtain high dimensional vectors corresponding to the documents. Each high dimensional vector corresponds to a digital document.

Clustering to label each digital document with a topic: In some cases, the set of high dimensional vectors are transformed to a set of vectors with a lower dimension, as the lower dimension is easier to computer clustering. A clustering algorithm is applied to the set of vectors with the lower dimension. In some cases, the clustering includes t-distributed Stochastic Neighbor Embedding (t-SNE) and hierarchical clustering. A set of statistically significant words from each cluster from a topic of the cluster.

Factorizing different sets of probabilities to obtain one or more probabilities of one or more topics associated with each digital document: After labelling the documents with the topics, matrix factorization of the probabilities can be executed.

The matrices of different probabilities are expressed using the below relationship:
[word-document matrix of probabilities]=
   [word-topic matrix of probabilities]×[topic-document matrix of probabilities]

The factorizing computing process includes:
(a) Computing the word-document matrix of probabilities of words observed in each one of the plurality of digital documents. This can be done by the computing system counting the words in each of the digital documents.
(b) Computing a word-topic matrix of probabilities of the words observed in each topic. This can be done by counting the words in each cluster of digital documents associated with a topic.
(c) Computing a topic-document matrix of probabilities of each one of the plurality of topics in each one of the plurality of the digital documents based on the word-document matrix of probabilities and the word-topic matrix of probabilities.
(d) Computing the topic-document matrix of probabilities of each one of the plurality of topics in each one of the plurality of the documents is done by factorizing the word-document matrix of probabilities by the word-topic matrix of probabilities. This factorizing is based on the above relationship between the matrices of different probabilities.

In some cases, in the process of computing the topic-document matrix of probabilities, the process includes encoding the embedding in the word-topic matrix of probabilities. Then, in some cases, the factorizing process computes the topic-document matrix of probabilities that maximizes the likelihood of observing the word-document matrix of probabilities.

Computing the topic distribution for each digital document: The computing system then computes and outputs a topic distribution for each one of the plurality of digital documents. A given topic distribution comprises one or more probabilities of one or more topics, from amongst the plurality of topics, which are associated with a given digital document.

In some cases, the computing system automatically discovers topics based on contextual meaning, and groups documents based on contextual similarity. In some cases, the computing system is integrated into a call center for processing transcripts or feedback from calls. For example, the transcripts of a call are considered digital documents, or the feedback comments from a call are considered digital documents, or both. In some cases, the computing system is integrated into a customer relationship management (CRM) computing platform.

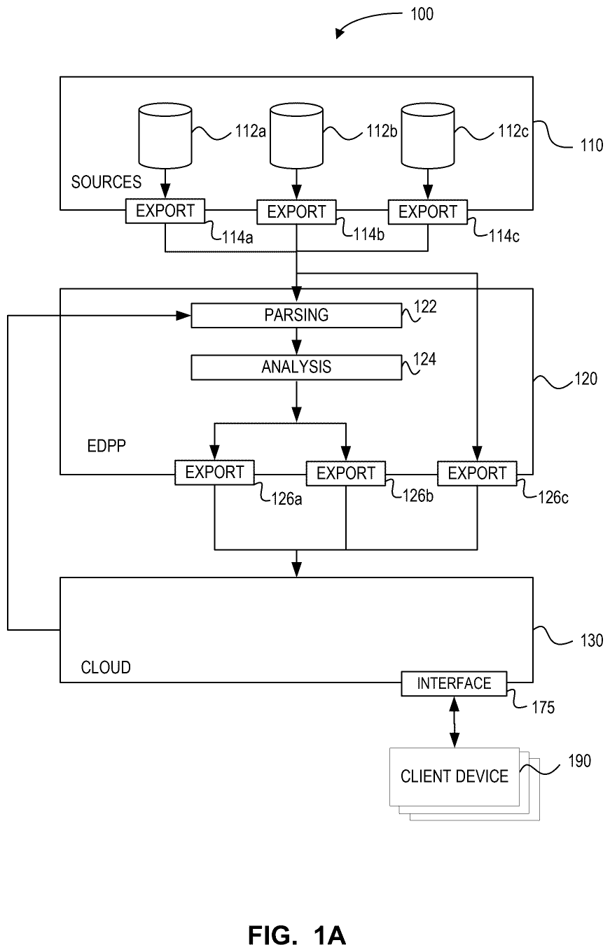

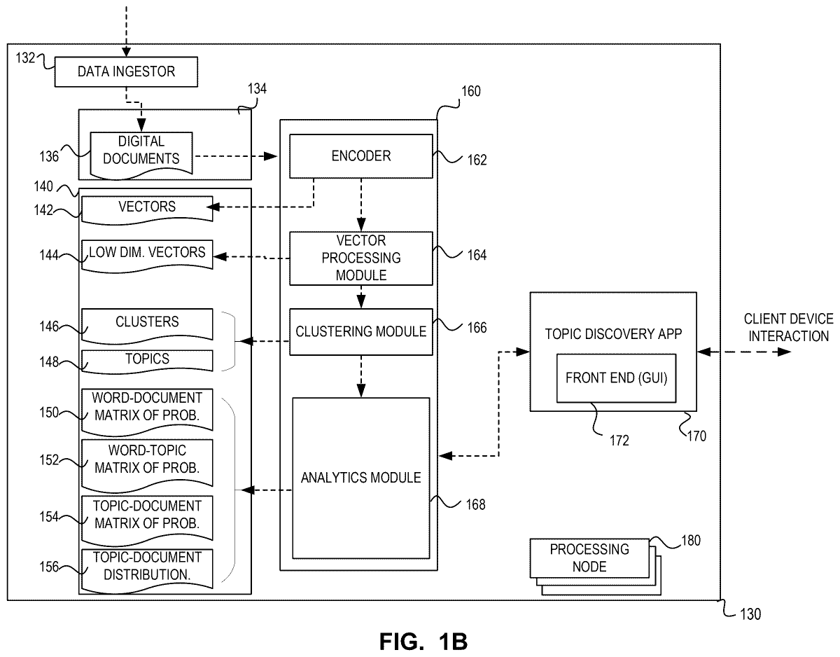

Referring now to FIG. 1A, there is illustrated a block diagram of an example computing system, in accordance with at least some embodiments. Computing system 100 includes an external source database system 110, an enterprise data provisioning platform (EDPP) 120 operatively coupled to the external source database system 110, and a cloud-based computing cluster 130 that is operatively coupled to the EDPP 120. In some cases. this computing system 100 is provided for automated data processing of large data sets, including computing data regarding fraudulent entities from different data source.

The external source database system 110 include multiple data source systems that each include one or more databases, of which three are shown for illustrative purposes: database 112a, database 112b and database 112c. One or more of the databases of the external data sources 110 may contain confidential information that is subject to restrictions on export. One or more export modules 114a, 114b, 114c may periodically (e.g., daily, weekly, monthly, etc.) export data from the databases 112a, 112b, 112c to EDPP 120. In some instances, the data is exported on an ad hoc basis.

EDPP 120 receives source data exported by the export modules 114 of external source database system 110, processes it and exports the processed data to an application database within the cloud-based computing cluster 130. For example, a parsing module 122 of EDPP 120 may perform extract, transform and load (ETL) operations on the received source data.

In many environments, access to the EDPP may be restricted to relatively few users, such as administrative users. However, with appropriate access permissions, data relevant to an application or group of applications (e.g., including software tools) may be exported via reporting and analysis module 124 or an export module 126. In particular, parsed data can then be processed and transmitted to the cloud-based computing cluster 130 by a reporting and analysis module 124. Alternatively, one or more export modules 126 can export the parsed data to the cloud-based computing cluster 130.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. To comply with such restrictions, one or more module of EDPP 120 may “de-risk” data tables that contain confidential data prior to transmission to cloud-based computing cluster 130. This de-risking process may, for example, obfuscate or mask elements of confidential data, or may exclude certain elements, depending on the specific restrictions applicable to the confidential data. The specific type of obfuscation, masking or other processing is referred to as a “data treatment.”

In some cases, data produced from the cloud-based computing cluster 130 is fed back to the EDPP 120 and is parsed using the parsing module 122. For example, data about viewers viewing the published data (e.g., herein generally called “viewing data”) is fed back to the parsing module 122. In some cases, analytics data that is computed by the cloud-based computing cluster 130 is fed back to the parsing module 122. It will be appreciated that other types of data could be fed back to the parsing module 122.

In some cases, an interface 175 of the cloud-based computing cluster 130 facilitates data communication with one or more client devices 190. In some cases, a client device transmits data requests (e.g., read, write, update, and/or delete requests) to the cloud-based computing cluster to interact with data stored thereon, an analytics module, or a topic discovery application, or a combination thereof. In some cases, a client device is a desktop computer, or a mobile device (e.g., laptop, smartphone, or tablet), or other types of user devices.

Referring now to FIG. 1B, there is illustrated a block diagram of the cloud-based computing cluster 130, showing greater detail of the elements of the cluster, which may be implemented by computing nodes of the cluster that are operatively coupled.

The components of the cloud-based computing cluster 130 include a data ingestor 132 and an analytics tool 160. In some cases, the analytics tools is implemented as a data-as-a-service. In some cases, the components of the cloud-based computing cluster 130 also include a datastore 134 for storing digital documents 136, an intermediary datastore 140 for storing intermediary data used in topic discovery computations, and a topic discovery application 170. In some cases, the topic discovery application is integrated into another application (e.g., a customer relations management application, a call-center application, a product analytics application, a social media platform, etc.).

A digital document herein refers to a digital text entry. In some cases, each digital text entry includes natural language. In some cases, each digital text entry is associated with a digital ID or a digital account. In some cases, a data file includes multiple digital text entries within a data file, and the data file is stored on the datastore 134. In some cases, there are multiple data files on the datastore 134, and each data file includes multiple digital documents. In some cases, a table in the datastore 134 stores the multiple digital documents. In some cases, there are multiple data files on the datastore 134, and each data file includes one digital document.

In some cases, the components of the cloud-based computing cluster 130 are implemented as one or more processing nodes 180. In some cases, the components of the cloud-based computing cluster are implemented as one or more virtual machines.

In some cases, the data ingestor 132, the datastore 134, the analytics tool 160, and the intermediary datastore 140 form a data pipeline for processing large numbers of digital documents. In some cases, the processing of this data pipeline occurs periodically and, in some other cases, the processing of this data pipeline occurs in real-time or near real-time as new digital documents are ingested by the data ingestor 132. In some cases, the outputs, which include the generated topics linked to the digital documents, are updated after new digital documents are ingested by the data ingestor 132 and processed by the analytics tool 160. In some cases, the updated outputs, which show one or more new generated topics based on one or more recently ingested digital documents, are transmitted to the topic discovery application 170 for display on a graphical user interface (GUI) 172.

In some cases, digital documents are ingested by the data ingestor 132 and are stored in the datastore 134. An encoder 162 in the analytics tool 160 processes each digital document to generate a corresponding vector. In other words, the encoder generates multiple vectors 142 that respectively correspond to the multiple digital documents 136. The vectors 142 are inputted into a vector processing module 164, which in some cases is part of the analytics tool 160, and the vector processing module respectively processes the same to generate multiple lower dimension vectors 144.

The multiple lower dimension vectors 144 are inputted into the clustering module 166. The clustering module 166 processes the multiple lower dimension vectors, which respectively correspond to the multiple digital documents, to generate one or more clusters 146. Each of the one or more clusters 146 is respectively processed to identify one or more topics 148.

The topics 148 are inputted into the analytics module 168, along with the digital documents 136. The analytics module 168 computes a word-document matrix of probabilities 150 and a word-topic matrix of probabilities 152. The analytics module 168 uses these matrices to then further compute a topic-document matrix of probabilities 154. The topic-document matrix of probabilities 154 is then used to compute a topic-document distribution 156 for each of the digital documents.

The topic-document distribution 156, or other related data or derived data, is provided to the topic discovery application 170 for display on a client device 190.

In some cases, intermediate data computed by the analytics tool 160 is stored in the intermediate datastore 140. In some cases, the intermediate datastore includes the vectors 142, the low dimension vectors 144, the clusters 146, the topics 148, the word-document matrix of probabilities 150, the word-topic matrix of probabilities 152, the topic-document matrix of probabilities 154, and the topic-document distribution 156. In some cases, instances of the intermediate data include a time-stamp to track versions and changes to the data over time.

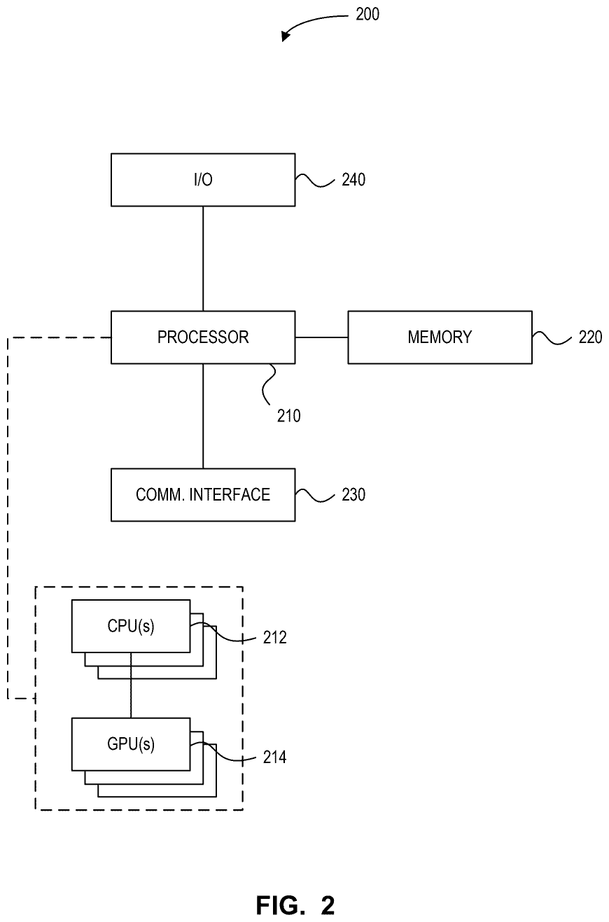

Referring now to FIG. 2, there is illustrated a simplified block diagram of a computer in accordance with at least some embodiments. Computer 200 is an example implementation of a computer such as source database system 110, EDPP 120, processing node 180 of FIGS. 1A and 1B. Computer 200 has at least one processor 210 operatively coupled to at least one memory 220, at least one communications interface 230 (also herein called a network interface), and at least one input/output device 240.

The at least one memory 220 includes a volatile memory that stores instructions executed or executable by processor 210, and input and output data used or generated during execution of the instructions. Memory 220 may also include non-volatile memory used to store input and/or output data-e.g., within a database-along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs and one or more Graphical Processing Units (GPUs) 214 that are coupled together.

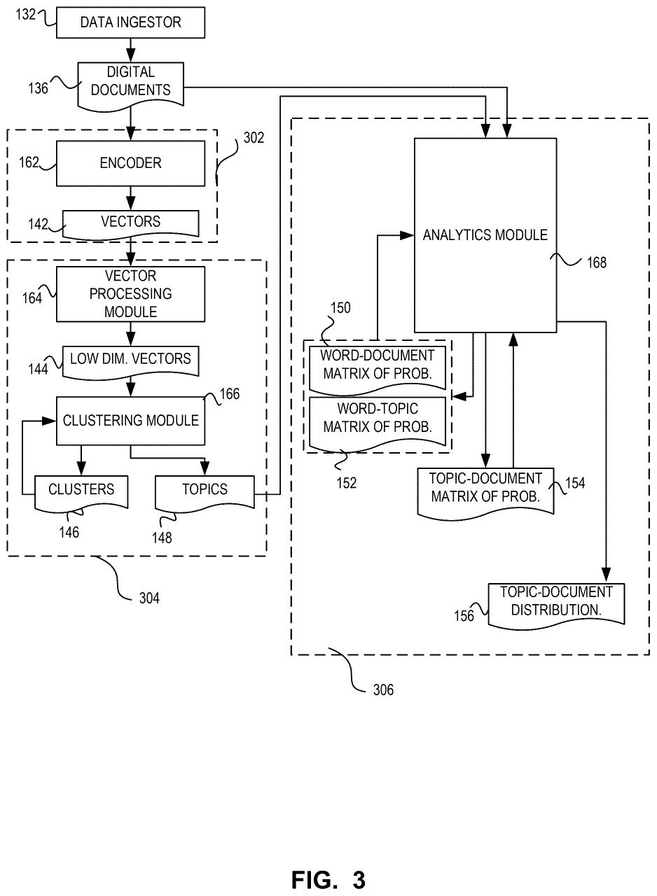

Referring now to FIG. 3, an example flow of data for generating the topics linked to digital documents is provided.

The data ingestor 132 ingests the digital documents 136, which are then inputted into the encoder 162 for an embedding process 302. In some cases, the encoder uses a transformer-based model to generate embeddings to learn the contextual meaning of the verbatim (e.g., also called natural language). The embeddings can then be later grouped (e.g., also called clustered) according to their contextual similarity.

In some cases, the encoder 162 uses a BERT architecture, which uses a neural network for language processing. The BERT architecture includes a tokenizer module, an embedding module, an encoder module, and a task head module. The tokenizer module converts a segment of text into a sequence of numbers (also called “tokens”). The embedding module converts the sequence of tokens into an array of real-valued vectors representing the tokens. The encoder module includes a stack of transformer blocks with self-attention. Transformer blocks with self-attention process tokens and predict a next token in a context. In some cases, this process includes transforming the input sequence of tokens into a query vector, key vector and value vector. The task head module converts the final representation of vectors into one-hot encoded tokens by producing a predicted probability distribution over the token types. It can be viewed as a simple decoder, decoding the latent representation into token types, or as an “un-embedding layer”. Vectors 142 are outputted, by the encoder 162, that respectively correspond to the digital documents 136. Each of these vectors can be represented on a m-dimensional graph, where m is a number that also corresponds to the size of each vector (e.g., also referred to as the number of elements in each vector).

In some other cases, the encoder 162 uses a RoBERTa (Robustly Optimized BERT Pretraining Approach) architecture. In some other cases, another type of LLM (large language model) is used for the encoder 162.

In some cases, the encoder 162 is executed using one or more GPUs 214.

In some cases, m is a high number, and performing clustering on vectors with a higher number of dimensions could consume more computing resources (e.g., computing time, hardware resources, memory resources, etc.). In some cases, the vector processing module 164 processes the vectors 142 to generate lower dimension vectors (also referred to as low dimension vectors 144), which have a size or dimension of n, where n is a number less than m. This reduces the computational burden for a topic grouping process based on context 304.

The clustering module 166 includes graphing the vectors in a graph and identifying clusters 146 of vectors within the graph. In some cases, the low dimension vectors 144 are represented as datapoints in a two or three-dimensional graph. In some cases, the graphing computation uses t-SNE. In some other cases, other data visualization techniques are used. In some cases, a hierarchical clustering computation is used to identify the clusters. In some other cases, a different type of clustering computation is used.

In some cases, each cluster is associated with a set of statistically significant words. These set of statistically significant words form a topic of the cluster. In some cases, the statistically significant words are obtained from reviewing the digital documents corresponding to the low dimension vectors that are in the cluster. For example, a first cluster is associated with the statistically significantly words Word1a, Word1b, Word1c, and Word 1d; and the topic for the first cluster is a combination of Word1a, Word1b, Word1c, and Word 1d. For example, a second cluster in the same graph is associated with the statistically significantly words Word2a, Word2b, Word2c, and Word 2d; and the topic for the second cluster is a combination of Word2a, Word2b, Word2c, and Word 2d. The topic is used to label the vectors (and corresponding digital documents) in the cluster. In some cases, after identifying the clusters, the computing system looks at each cluster to identify the words that are statistically significant, and these words form the topics 148 respectively corresponding to each cluster (e.g., as a topic label). In some cases, a given topic of a given cluster is linked to a group of digital documents, whereby the group of digital documents correspond to the low dimension vectors within the given cluster.

In some cases, one or more clusters are grouped together to form larger clusters, and each larger cluster is associated with a higher-level topic. The higher-level topic is derived from or is a subset of words from the set of statistically significant words in the topics of the clusters that from a given larger cluster. The higher-level topic is used to label the vectors (and corresponding digital documents) in the larger cluster. In some cases, smaller clusters that are below a certain size (e.g., clusters that have number vectors below a threshold number of vectors) and that are within a threshold proximity to each other in the graph (e.g., within a threshold distance from each other in the graph) are automatically grouped together to form a larger cluster. In some cases, automatically grouping smaller clusters to form a larger cluster helps to reduce the number of topics for further processing, thereby reducing the processing. In some other cases, a smaller number of topics may also be desirable to an end user for their understanding.

In some cases, the embedding and clustering process is context-aware. In some cases, the process does not need to rely on pre-determined topics, and can discover new topics. In some cases, the process does not use word co-occurrence explicitly.

A process of topic grouping based on context and word statistics 306 is then executed by the computing system.

In particular, the topics 148 and the digital documents 136 are processed by the analytics module 168. The analytics module 168 computes a word-document matrix of probabilities 150, which include the probabilities of words being in each digital document. In some cases, the probabilities are computed by the computing system counting the number of each word instance in a digital document. The analytics module 168 also computes a word-topic matrix of probabilities 152, which is based on the computing system counting the number of each word instance within each cluster of digital documents associated with a given topic. In other words, the grouping of digital documents with each cluster are provided to the analytics module 168.

The analytics module 168 then computes the topic-document matrix of probabilities 154, which includes the probabilities of each one of the plurality of topics in each one of the plurality of the documents, by factorizing the word-document matrix of probabilities 150 by the word-topic matrix of probabilities 152. This factorizing is based on the above relationship: [word-document matrix of probabilities 150]=
[word-topic matrix of probabilities 154]×[topic-document matrix of probabilities 154].

The topic-document distribution 156 is then derived for each digital document.

In some cases, the topic distribution for each one of the documents is a Dirichlet distribution.

In some cases, the output is a graph showing the distribution of the topics associated with each document. In some cases, only the w-highest statistically significant topics that associated with a given document are displayed in the graph. In some cases, w is a natural number.

In some cases, the technical drawbacks and strengths of the encoding and clustering process, followed by matrix factorization balance each other. For example, the encoding and clustering computations may be effective at processing context awareness in relation to topics, and may have a drawback of not explicitly using word co-occurrence. In natural language processing computations, word co-occurrence refers to the frequency with which two or more words appear together in a corpus of text. In another example, the matrix factorization process is effective at using word co-occurrence explicitly, and may have a drawback of lacking capability to process the context for a topic. In some cases, as described above, computing the encoding process and clustering process in prior steps, and then later computing the matrix factorization, helps to compute the topic-document matrix of probabilities that is both context-aware and uses word co-occurrence explicitly.

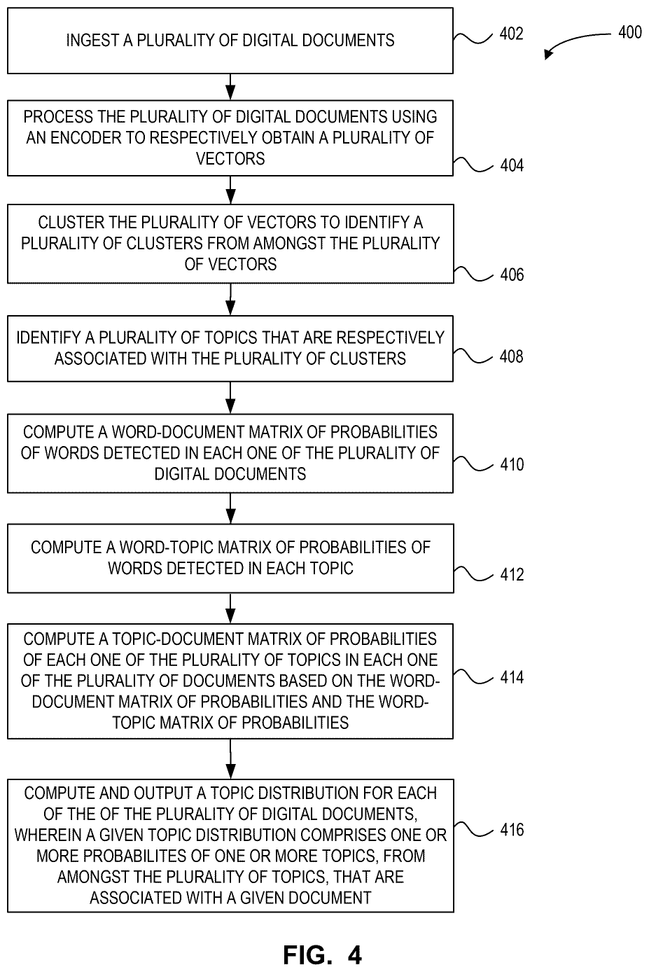

Referring to FIG. 4, a process 400 is provided for automatically generating topics from digital documents.
Block 402: Ingest a plurality of digital documents.
Block 404: Process the plurality of digital documents using an encoder to respectively obtain a plurality of vectors.
Block 406: Cluster the plurality of vectors to identify a plurality of clusters from amongst the plurality of vectors.
Block 408: Identify a plurality of topics that are respectively associated with the plurality of clusters.
Block 410: Compute a word-document matrix of probabilities of words detected in each one of the plurality of documents.
Block 412: Compute a word-topic matrix of probabilities of words detected in each topic.
Block 414: Compute a topic-document matrix of probabilities of each one of the plurality of topics in each one of the plurality of documents based on the word-document matrix of probabilities and the word-topic matrix of probabilities.
Block 416: Compute and output a topic distribution for each of the of the plurality of documents, wherein a given topic distribution comprises one or more probabilities of one or more topics, from amongst the plurality of topics, that are associated with a given document.

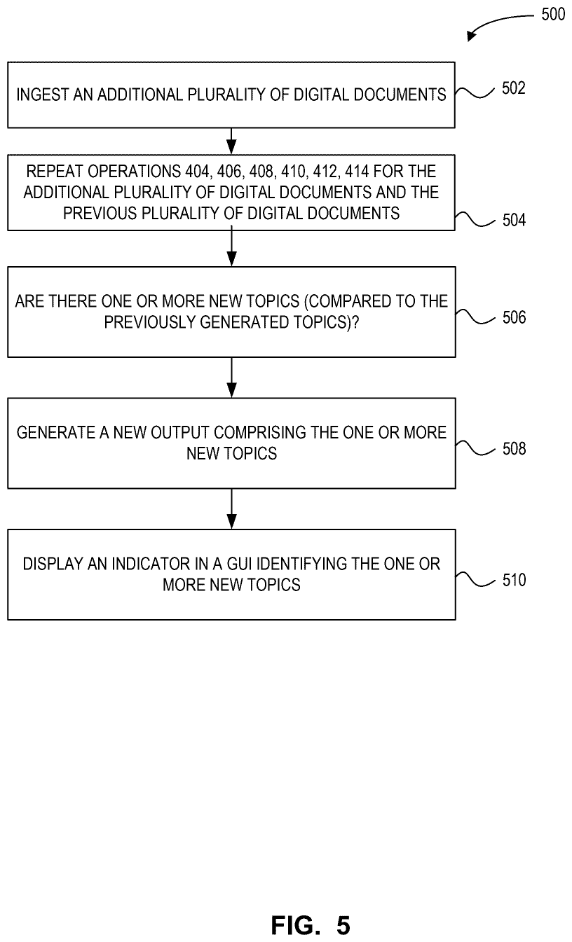

Referring to FIG. 5, a method 500 is provided for repeating the process 400 to discover new topics, compared to a previously generated set of topics. In other words, the method 500 occurs after at least one instance of the process 400 has been executed. In some cases, the method 500 is applied when ingesting additional digital documents. In some cases, the data ingestor 132 periodically or continuously receives additional digital documents over time. The text content of these additional digital documents is used to discover new topics, and automatically bring these new topics for attention via a GUI or a message alert system.
Block 502: The computing system ingests an additional plurality of digital documents.
Block 504: The computing system executes the operations at blocks 404, 406, 408, 410, 412 and 414 for the additional plurality of digital documents and the previous plurality of digital documents. In some cases, this results in new clusters. In some cases, this also results in generating one or more new topics, compared to the previously generated topics.
Block 506: The computing system determines if there are one or more new topics that have been generated in comparison to the previously generated topics.
Block 508: If so, the computing system generates a new output comprising the one or more new topics. In some cases, the new output includes a topic distribution for each of the of the plurality of digital documents, which includes the one or more new topics and the additional plurality of digital documents. For example, the one or more new topics may a label applied to previous digital documents, but were considered previously too statistically insignificant. In some case, the one or more new topics are only applicable to the additional plurality of digital documents.
Block 508: The computing system render a GUI that displays an indicator identifying the one or more new topics from amongst the plurality of topics. In some cases, the computing system also sends a message to alert a data account (e.g., email account, user account, etc.) that there are one or more new topics that have been discovered.

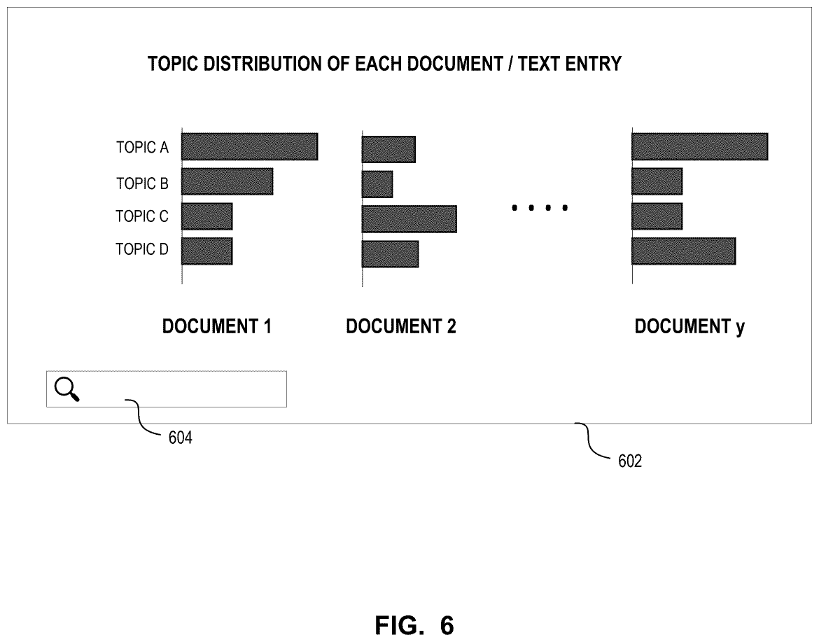

Turning to FIG. 6, an example of an output 602 is shown, which could be rendered in a GUI 172 displayed on a client device 190.

The output 602 shows the distribution of topics (e.g., topic A, topic B, topic C, topic D, etc.) distributed across each digital document (e.g., document 1, document 2, . . . , document y).

In some cases, the output is updated after new digital documents are ingested and processed. In some other cases, an alert is shown in the GUI 172 when a new topic is discovered, or when a topic's statistical significance rises by a certain amount, or when a topic is newly established in the top five most statistically significant topics, or a combination thereof.

In some cases, the GUI 172 includes a search tool 604 to receive search terms and initiate searches for topics within certain groups of segments. In some cases, the GUI 172 shows visualizations of the clusters in a graph.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A server system for automatically generating a plurality of topics from a plurality of digital documents, the server system comprising:
a memory, a network interface, and a processor, the processor operably coupled to the memory and the network interface, the processor configured to:
ingest the plurality of digital documents;
process the plurality of digital documents using an encoder to respectively obtain a plurality of vectors;
cluster the plurality of vectors to identify a plurality of clusters from amongst the plurality of vectors;
identify the plurality of topics that are respectively associated with the plurality of clusters;
compute a word-document matrix of probabilities of words detected in each one of the plurality of digital documents;
compute a word-topic matrix of probabilities of words detected in each topic;
compute a topic-document matrix of probabilities of each one of the plurality of topics in each one of the plurality of digital documents based on the word-document matrix of probabilities and the word-topic matrix of probabilities; and
compute and output a topic distribution for each of the plurality of digital documents, wherein a given topic distribution comprises one or more probabilities of one or more topics, from amongst the plurality of topics, that are associated with a given digital document.

2. The server system of claim 1, wherein the processor is configured to compute the topic-document matrix of probabilities of each one of the plurality of topics in each one of the plurality of the digital documents by at least factorizing the word-document matrix of probabilities by the word-topic matrix of probabilities.

3. The server system of claim 1, wherein a given topic, from amongst the plurality of topics, comprise one or more statistically significant words found in a given cluster of documents from amongst the plurality of clusters.

4. The server system of claim 1, wherein each of the plurality of digital documents comprises natural language, and the plurality of digital documents are transformed into the plurality of vectors using a natural language neural network model.

5. The server system of claim 1, wherein the processor is configured to transform the plurality of documents into the plurality of vectors by at least:
transforming the plurality of documents into a plurality of high dimensional vectors with a first number of dimensions, using a bidirectional encoder representations from transformers (BERT) model in the encoder;
transform the plurality of high dimensional vectors to the plurality of vectors, wherein the plurality of vectors has a second number of dimensions less than the first number of dimensions.

6. The server system of claim 1, wherein the processor is configured to compute the topic distribution for each one of the plurality of digital documents as a Dirichlet distribution.

7. The server system of claim 1, wherein the processor is further configured to compute a graph of the plurality of vectors, each one of the plurality of vectors associated with a set of statistically significant words observed respectively in each one of the plurality of documents, wherein the each one of the plurality of vectors respectively corresponds to the each one of the plurality of digital documents.

8. The server system of claim 1, wherein the processor is further configured to render a graphical user interface that displays at least the given topic in association with the given digital document, or an identifier of the given digital document.

9. The server system of claim 1, wherein the processor is further configured to ingest an additional plurality of digital documents; process the additional plurality of digital documents along with the plurality of digital documents to determine if there are one or more new topics; and, when there are one or more new topics, generate a new output comprising the one or more new topics.

10. The server system of claim 9, wherein the processor is further configured to render a graphical user interface that displays an indicator identifying the one or more new topics from amongst the plurality of topics.

11. A method for automatically generating a plurality of topics from a plurality of digital documents, the method executed in a computing environment comprising one or more processors and memory, the method comprising:
ingesting the plurality of digital documents;
processing the plurality of digital documents using an encoder to respectively obtain a plurality of vectors;
clustering the plurality of vectors to identify a plurality of clusters from amongst the plurality of vectors;
identifying the plurality of topics that are respectively associated with the plurality of clusters;
computing a word-document matrix of probabilities of words detected in each one of the plurality of digital documents;
computing a word-topic matrix of probabilities of words detected in each topic;
computing a topic-document matrix of probabilities of each one of the plurality of topics in each one of the plurality of digital documents based on the word-document matrix of probabilities and the word-topic matrix of probabilities; and
computing and outputting a topic distribution for each of the plurality of digital documents, wherein a given topic distribution comprises one or more probabilities of one or more topics, from amongst the plurality of topics, that are associated with a given digital document.

12. The method of claim 11, further comprising computing the topic-document matrix of probabilities of each one of the plurality of topics in each one of the plurality of the digital documents by at least factorizing the word-document matrix of probabilities by the word-topic matrix of probabilities.

13. The method of claim 11, wherein a given topic, from amongst the plurality of topics, comprises one or more statistically significant words found in a given cluster of documents from amongst the plurality of clusters.

14. The method of claim 11, wherein each of the plurality of documents comprises natural language, and the plurality of digital documents are transformed into the plurality of vectors using a natural language neural network model.

15. The method of claim 11, further comprising processing the plurality of documents to generate the plurality of vectors by at least:
transforming the plurality of documents into a plurality of high dimensional vectors with a first number of dimensions, using a bidirectional encoder representations from transformers (BERT) model in the encoder;
transforming the plurality of high dimensional vectors to the plurality of vectors, wherein the plurality of vectors has a second number of dimensions less than the first number of dimensions.

16. The method of claim 11, further comprising computing the topic distribution for each one of the plurality of digital documents as a Dirichlet distribution.

17. The method of claim 11, further comprising computing a graph of the plurality of vectors, each one of the plurality of vectors associated with a set of statistically significant words observed respectively in each one of the plurality of documents, wherein the each one of the plurality of vectors respectively corresponds to the each one of the plurality of digital documents.

18. The method of claim 11, further comprising rendering a graphical user interface that displays at least the given topic in association with the given digital document, or an identifier of the given digital document.

19. The method of claim 11, further comprising ingesting an additional plurality of digital documents; process the additional plurality of digital documents along with the plurality of digital documents to determine if there are one or more new topics; when there are one or more new topics, generating a new output comprising the one or more new topics; and rendering a graphical user interface that displays an indicator identifying the one or more new topics from amongst the plurality of topics.

20. A non-transitory computer readable medium storing computer executable instructions which, when executed by at least one computer processor, cause the at least one computer processor to carry out a method for generating a plurality of topics from a plurality of digital documents, the method comprising:
ingesting the plurality of digital documents;
processing the plurality of digital documents using an encoder to respectively obtain a plurality of vectors;
clustering the plurality of vectors to identify a plurality of clusters from amongst the plurality of vectors;
identifying the plurality of topics that are respectively associated with the plurality of clusters;
computing a word-document matrix of probabilities of words detected in each one of the plurality of digital documents;
computing a word-topic matrix of probabilities of words detected in each topic;
computing a topic-document matrix of probabilities of each one of the plurality of topics in each one of the plurality of digital documents based on the word-document matrix of probabilities and the word-topic matrix of probabilities; and
computing and outputting a topic distribution for each of the plurality of digital documents, wherein a given topic distribution comprises one or more probabilities of one or more topics, from amongst the plurality of topics, that are associated with a given digital document.
